(19) United States
(12) Patent Application Publication
(10) Pub. No.: US 2024/0188591 A1
(43) Pub. Date: Jun. 13, 2024

(54) METHOD FOR MANUFACTURING A WET ANIMAL FOOD PRODUCT, WET ANIMAL FOOD PRODUCT, AND APPARATUS FOR MANUFACTURING IT

(71) Applicant: Fair Food P&S GmbH, Laudenbach (DE)

(72) Inventor: Klaus Wagner, Laudenbach (DE)

(21) Appl. No.: 18/500,466

(22) Filed: Nov. 2, 2023

(30) Foreign Application Priority Data
Dec. 8, 2022 (DE) 20 2022 106 874.7
May 11, 2023 (DE) 20 2023 102 557.9

(51) Int. Cl. A23K 40/00; A23K 10/30; A23K 20/147; A23K 20/158; A23K 20/163; A23K 30/00; A23K 50/45; A23N 17/00; B65B 3/00; B65B 7/02; B65B 51/22; B65B 55/04; B65B 55/12

(52) U.S. Cl. CPC A23K 40/00; A23K 10/30; A23K 20/147; A23K 20/158; A23K 20/163; A23K 30/00; A23K 50/45; A23N 17/004; A23N 17/007; B65B 3/00; B65B 7/02; B65B 51/225; B65B 55/04; B65B 55/12

(57) ABSTRACT

A method for manufacturing a wet food product for animals can include mixing solid animal feed components with a sauce or sauce components in a temperature-controllable process reactor and sterilising the mixture by heat treatment in the process reactor. The mixing and sterilising can occur at the same time. Embodiments can utilize an apparatus that can include a reactor to receive solid animal feed components and a sauce or sauce components, a temperature control device to control the temperature of the reactor (e.g. at least one wall of the reactor), a mixing device to mix the components located in the reactor (e.g. an agitator within the reactor, etc.), and a control device to control the mixing device to mix the components in the process reactor and to control the temperature control device to sterilise the components or mixture in the reactor.

### CROSS-REFERENCE TO RELATED APPLICATIONS

The present application claims priority to German Utility Model Patent Application No. DE 20 2022 106 874.7 filed on Dec. 8, 2022 and German Utility Model Patent Application No. DE 20 2023 102 557.9 filed on May 11, 2023.

The entirety of German Utility Model Patent Application Nos. DE 20 2022 106 874.7 and DE 20 2023 102 557.9 are incorporated by reference herein.

### FIELD

The present innovation relates to a method for manufacturing a wet animal food product for animals, to the wet food product and to an apparatus for manufacturing it.

### BACKGROUND

Normally, wet food products for pets are based on animal meat or animal by-products, restructured meat or meat substitutes (a combination of meat/animal by-products and plant protein). The wet food products contain more than 45% moisture, typically approximately 65% to approximately 82% moisture, and a have a water activity greater than 0.9. There are two main types of wet food for pets. The first type is typically manufactured by processing a mixture of edible components while heating so as to produce a homogeneous, cohesive semisolid mass, which is structured by heat-coagulated protein known as a “pâté” or “meatloaf”. The second kind of wet food for pets is typically prepared by combining pieces of meat or restructured meat with a sauce (e.g., sauce, jelly or mousse), known as “chunks in gravy”. These wet food products contain considerable amounts of meat and animal by-products.

The use of edible fungi and plant proteins in wet food for pets can replace meat in terms of texture and amino acid profile.

EP 3292759 relates to a method for manufacturing a meat-free product on the basis of edible fungi of the genus Pleurotus, in particular of the species Pleurotus eryngii. The meat-free product is manufactured in four steps. In the first step, edible fungi are comminuted into small pieces, this being followed by a second step of mixing the comminuted edible fungi with plant oil, a source of starch, animal and/or plant proteins, and salt to form a homogeneous compound. The resulting homogeneous mass is heated in moulds in a third step, and subsequently cooled in the open or closed mould to form a solidified meat-free product.

CN111642648 discloses a protein-rich cat and dog treat manufactured from artificial plant protein meat, liver, sunflower oil, egg yolk and other ingredients, while the artificial plant protein meat consists of dried Pleurotus eryngii protein powder and soybean protein.

CN106260680 discloses an animal food manufactured by mixing animal products such as pork, lard oil, fishmeal, chicken livers and vegetables, including enoki mushrooms.

### SUMMARY

An object for embodiments of the invention can be to solve the problems of the prior art, without compromises to quality, taste and hygiene. For instance, embodiments can be configured to provide a wet food product for animals, in particular pets, which can be manufactured from high-availability raw materials, is high-quality, tasty and sanitary, and is also distinguished by a comparable texture and similar nutrient profile to meat-based wet food for pets, the manufacture thereof being non-labour-intensive, non-time-consuming and cost-effective, having a good energy balance and being environmentally friendly, and a corresponding apparatus for manufacturing a wet food product.

Embodiments can be configured for manufacturing a wet food product for animals, in particular pets (e.g. dogs, cats, etc.), via a manufacturing method that can include the following steps:
mixing solid animal feed components with a sauce or sauce components in a temperature-controllable process reactor and
sterilising the mixture by heat treatment in the process reactor.

In an advantageous embodiment, the following steps can also be provided:
mixing solid animal feed components, including edible fungi and plant and/or animal protein, with a sauce or sauce components and optionally further components, including starch, in particular in the form of a source of starch, oil, in particular plant oil, minerals, vitamins and flavour enhancers, in a temperature-controllable process reactor, in such a way that the mixture comprises 5 to 20% by weight edible fungi and either ≤10% by weight plant proteins or 20 to 30% by weight animal proteins, and
sterilising the mixture by heat treatment in the process reactor in such a way that after sterilisation the mixture has a dry mass content ≤55%, in particular approximately 35 to 18%, and a water activity ≥0.9.

In some embodiments, as well as the 5 to 20% by weight edible fungi, the mixture can advantageously contain ≤10% by weight plant proteins, ≤1% by weight, in particular ≤0.1% by weight animal proteins, ≤15% by weight source of starch, and ≤15% by weight, preferably ≤10% by weight plant oil, minerals, vitamins and flavour enhancers to obtain a vegan wet food product free of animal feed components.

A wet pet food product is also provided. The wet pet food product can be prepared using edible fungi and plant proteins which is as similar as possible to animal meat or meat-derived products in terms of textural and nutritional benefits. The plant protein is preferably selected from pea protein concentrate/isolate, soy protein concentrate/isolate, wheat protein concentrate/isolate, sunflower protein, rapeseed protein, chickpea protein, lupine protein, broad bean protein concentrate, pumpkin seed protein, duckweed protein, mycoprotein, peanut protein, hemp protein, quinoa, chia, amaranth, lentils, chickpeas, buckwheat, spelt, pasta (whole wheat pasta, chickpea pasta), rice and combinations thereof. Selection of the plant protein from legume protein is advantageously also possible. The use of edible fungi and plant proteins in wet food for pets can successfully replace meat in terms of texture and amino acid profile, greatly lower costs, reduce the CO₂ footprint and simultaneously maintain the overall nutrient profile and quality of the end product.

The edible fungus is preferably selected either from the basidiomycetes belonging to the pleurotaceae family, including Agaricales, Agaricomycetes, or from Pleurotus ostreatus and Pleurotus eryngii. Edible fungi from the basidiomycetes family, which belong to the pleurotaceae family, provide texture, aroma and flavour, in addition to the possible effect on health for the bioactive compounds. Pleurotus fungi are rich in proteins and essential amino acids, meaning that they can be a replacement for meat nutrition. They comprise fibres, carbohydrates, water-soluble vitamins and minerals and a low fat content. Edible fungi of the genus Pleurotus are easy to cultivate and available in large amounts, and can be used freshly ground in different grades or particle sizes or as a “plant-based meat substitute”.

A wet food product for animals, in particular pets, which can be manufactured from high-availability raw materials, such as edible Pleurotus spp. fungi and plant proteins, can be provided. The wet feed for pets can have the advantage that the raw materials are used directly, resulting in the steps of adding the edible fungi in a pre-formed meat-free substitute being omitted; it is also distinguished by a comparable texture and similar nutrient profile to meat-based wet food for pets, and can be more cost-effective and have an improved energy balance.

The term “mixing” as used herein refers to the process of combining or putting together various foodstuff components to form a substance or mass.

In addition to the 5% to 20% by weight edible fungi, the mixture may also comprise 20% to 30% by weight animal protein in the form of meat and/or animal by-products and ≤15% by weight source of starch, oil, minerals, vitamins and flavour enhancers, so as to obtain a flexitarian wet food product.

The term “fungus” thus refers to the edible fruiting body (sporophore) of particular fungi.

The term “plant protein” used herein refers to foodstuff products manufactured by reducing or removing the most significant non-protein components (water, oil, starch, other carbohydrates) from plant materials.

The term “animal protein” used herein refers to proteins originating from vertebrates such as mammals, birds and fish. Animal protein may originate from muscle flesh, offal, tendons or bones. The animal protein is most preferably, but is not limited to, meat and offal from cattle, chicken, turkey, pheasant, quail, goat, sheep, buffalo, pig and combinations thereof.

The flavourings are preferably selected from hydrolysed plant and/or animal protein-hydrolysed components, yeast-based products, spices or combinations thereof, but are not limited thereto. The term “flavours” as used herein refers to ingredient systems (liquid and dry or a combination of the two) developed specially to improve the nutrient uptake of an animal.

Sterilisation, within the meaning of the invention, means a heat treatment which makes the wet food product technically germ-free. Technical freedom from germs can, but does not have to, be absolute freedom from germs in the sense that not a single active germ is present, and instead means a freedom from germs which ensures, with sufficient probability, a harmless intake for a fixed period (shelf life, for example 6 or 12 or 18 or 24 months) under fixed storage conditions. Technical freedom from germs may for example be specified by an F-value of LOG 4, meaning that 99.99% of all germs originally present in a sample have been deactivated (F-value=3). Mixing means any degree of mixing. In particular, the mixing and sterilisation are not to be understood as needing to be separate, successive processes. Rather, the mixing and the sterilisation or heat treatment may take place in the process reactor simultaneously in some embodiments. As a result of the steps of mixing and sterilisation being combined in a temperature-controllable process reactor, the manufacturing process for a wet food product can be considerably simplified, shortened, and optimised in terms of energy, preservation of nutrients, in particular vital substances, and preservation of flavourings, since autoclaving of the fully packaged product is omitted. In particular, the sterilisation process itself can be shortened considerably, since it takes place directly on the product in the process reactor and not only after packing. This also simplifies a subsequent packing process. Conventionally, the sauce is not mixed into the solid components until during packing, necessitating (at least) two packing steps. When, the animal food product comes out of the process reactor as a finished mixture, the packing process can be configured to be single-step and continuous. After the sterilisation, the mixture/product advantageously has a dry mass content ≤55%, in particular approximately 35% to 18%, and a water activity ≥0.9, and therefore constitutes a wet food product for animals. The term “aseptic packing” as used herein refers to a process of packing the sterilised wet food product into a pre-sterilised packaging material of foodstuff quality, followed by hermetic sealing. In particular, the sterilisation process itself can be shortened considerably, since it takes place directly on the product in the process reactor and not only after packing.

The method may further include:
aseptically packing the sterilised mixture into sterile containers, the sterile containers preferably
   being plastics material bags or tubular bags or tubular film bags or pouch bags or film bags comprising a standing base or bowls, and/or
   having a capacity of at least 100 g or at least 200 g or at least 400 g or at least 1200 g and/or at most 2000 g or at most 1200 g of the sterilised mixture.

The method may further include:
sterile sealing of the sterile containers after filling, the sealing preferably comprising detectable ultrasound sealing, the sterile containers being plastics material bags or tubular bags or tubular film bags or pouch bags or film bags comprising or not comprising a standing base or bowls.

A slow cooker may be used as a process reactor.

The heat treatment may comprise heating to a sterilisation temperature and maintaining at the sterilisation temperature for a sterilisation period, the sterilisation temperature preferably being at least 110° C. or at least 120° C. and/or at most 130° C. or at most 125° C. or at most 122° C. or at most 121° C., and the sterilisation period preferably being at most 10 minutes or at most 5 minutes or at most 3 minutes.

In the process reactor, a pressure of at least 1 bar or at least 2 bar and/or at most 4 bar can be maintained at least during the heat treatment.

The process reactor may be sealed pressure-tight after filling, at least for the time of the heat treatment.

The method may further include:
cooking the mixture in the process reactor at a cooking temperature for a cooking period prior to sterilisation, the cooking temperature preferably being at most 90° C. or at most 75° C. or at most 60° C., and the cooking period preferably being at most 40 minutes or at most 30 minutes or at most 20 minutes and/or preferably being at least 5 minutes or at least 10 minutes or at least 15 minutes.

The method may further include at least one of the steps of:
preparing the sauce by adding the sauce components to water and subsequently mixing the sauce with the solid animal feed components, preferably with further mixing inside the process reactor,
providing the sauce by dispersing a predetermined amount of hydrocolloid mixture, the starch, the plant protein, the plant oil, the minerals, the vitamins, the flavour enhancers in water and mixing the sauce base for several minutes, preferably for at most 10 minutes or at most 5 minutes.

The method may further include:
cooling the sterilised mixture in the process reactor and/or
cooling the sterilised mixture prior to packing outside the process reactor and/or
cooling the packaged mixture in the containers.

In the method, the components are preferably put together in such a way that the contents of the packaged mixture include:
5% by weight or more, optionally 20% by weight or less, fresh edible fungi of the genus Pleurotus,
10% by weight or less plant protein,
0.1% by weight or less proteins of animal origin,
optionally 5% by weight or more vegetables and/or fruit,
15% by weight or less of a source of starch,
2% by weight or less hydrocolloid mixture,
10% by weight or less plant fat or oil,
0.5% by weight seeds,
mineral and vitamin premix (1%-2% by weight) and flavour enhancers (0.5%-2% by weight), remainder water and/or broth (30-50% by weight)

or
5% by weight or more, optionally 20% by weight or less, fresh edible fungi of the genus Pleurotus,
0.1% by weight or less plant protein,
20%-30% by weight animal proteins,
optionally 5% by weight or more vegetables and/or fruit,
15% by weight or less of a source of starch,
2% by weight or less hydrocolloid mixture,
0.1% by weight or less plant fat or oil,
0.5% by weight seeds,
mineral and vitamin premix (1%-2% by weight) and flavour enhancers (0.5%-2% by weight), remainder water and/or broth (30%-50% by weight).

The method for manufacturing the wet food product for animals, in particular pets, thus takes place using edible fungi and has, in an advantageous embodiment, the steps of:
comminuting edible fungi to a particle size substantially corresponding to the particle size of mince,
scaling the ground fungi to a predetermined amount and mixing the ground fungi with other vegetables and/or other ingredients to manufacture a non-aqueous component,
mixing cold water, with shear, with a hydrocolloid mixture, starch, plant proteins, oil, vitamins, minerals and flavourings to form an aqueous component,
mixing aqueous and non-aqueous components together and feeding this mixture into a container of the process reactor in the form of a slow cooker,
cooking the mixture under humid conditions at substantially 90° C. for 15 to 25 minutes at a negative pressure of 0.3 bar to 0.5 bar, which is built up in the slow cooker, while stirring continuously,
after the cooking is finished, sterilising the mixture in the same container at 120° C. or more for 3 minutes at a pressure of 1 to 2 bar, optionally also between 2 bar and 3 bar,
after the sterilisation, packing the mixture aseptically by weight into preformed bags, a single-phase hot or cold packing process at 80° C. to 85° C. or less being used,
bringing about a phase transition of the homogeneous mass of the mixture from a high-viscosity to a semisolid cohesive mass during packing, the mass being structured by heat-reversible biopolymers and taking on a shape of the packaging.

The term “comminution” refers to the process of comminuting or grinding foodstuffs into very small pieces, typically using a machine.

The term “cohesion” represents the structural integrity of a foodstuff product and refers to a property characterised by the strength of the internal bonding making up the body of a foodstuff product.

The term “cooking” or “slow cooking” refers to transmission of energy from a heat source to foodstuffs. This energy changes the molecular structure of the foodstuff and thus changes the flavour, aroma and appearance of foodstuffs.

A method which can manufacture a wet food product for animals, in particular pets, which can be manufactured from high-availability raw materials, is high-quality, tasty and sanitary, and is also distinguished by a comparable texture and similar nutrient profile to meat-based wet food for pets, the method of manufacture being non-labour-intensive, non-time-consuming and cost-effective, having a good energy balance and being environmentally friendly, and a corresponding apparatus for manufacturing a wet food product are thus provided.

A further aspect of the invention relates to a wet food product for animals, in particular pets, manufactured by an embodiment of the above method. The wet food product has the advantages of the above-described method; it is therefore also distinguished by improved nutrient content and flavour, and can moreover be more cost-effective and have an improved energy balance.

A further aspect of the invention relates to an apparatus for manufacturing a wet food product for animals, in particular pets. Embodiments of the apparatus can include:
a process reactor formed to receive solid animal feed components and a sauce or sauce components,
a temperature control device formed to temperature-control the process reactor, in particular walls of the process reactor,
a mixing device set up to mix the components located in the process reactor, and
a control device formed and configured to control the mixing device so as to mix the components in the process reactor and to control the temperature control device so as to sterilise the components or mixture in the process reactor by heat treatment.

In an advantageous embodiment, the apparatus comprises:
the process reactor, formed to receive solid animal feed components, including edible fungi and plant and/or animal protein, and a sauce or sauce components, and optionally further components, including starch, in particular in the form of a source of starch, oil, in particular plant oil, minerals, vitamins and flavour enhancers,
the temperature control device, formed to temperature-control the process reactor, in particular walls of the process reactor,
the mixing device, set up to mix the components located in the process reactor in such a way that the mixture comprises 5% to 20% by weight edible fungi and either ≤10% by weight plant proteins or 20% to 30% by weight animal proteins, and
the control device, formed and configured to control the mixing device so as to mix the components in the process reactor and to control the temperature control device so as to sterilise the components or mixture in the process reactor by heat treatment in such a way that after sterilisation the mixture has a dry mass content ≤55%, in particular approximately 35% to 18%, and a water activity ≥0.9.

An apparatus of this type can make possible a wet food product having the aforementioned advantages in terms of product quality, as a meat replacement product or flexitarian product, and process efficiency.

The process reactor may be configured as a slow cooker. The process reactor may be temperature-controlled via hotplates. In the apparatus, the temperature control device may accordingly comprise hotplates. The hotplates may be part of the process reactor. Temperature control via hotplates is particularly simple in terms of construction and can be controlled well. Further, the heat treatment can act on the mixture particularly directly. As a result, heating phases can be shortened, and the sterilisation temperature can be maintained reliably and with low expenditure of energy. The nutrient content, flavour, hygiene and energy balance of the product can be improved further, and the costs can be lower. Alternatively, the temperature may also be controlled via indirect or direct steam.

Aseptic packing of the sterilised mixture into sterile containers is preferably provided. Sterile sealing of the sterile containers after filling may also be provided. The sealing may comprise detectable ultrasound sealing. As a result, thoroughly aseptic treatment of the mixture sterilised in the process reactor until packing can be ensured. Exposure to germs prior to packing can thus be prevented. This also ensures that further sterilisation after packing is unnecessary.

In other words, the wet food product may comprise the sterilised mixture packaged into sterile containers. The sterile containers may have sealing established in a sterile manner, in particular detectable ultrasound sealing. A product of this type is particularly safe and, since there is no autoclaving, also particularly rich in nutrients, tasty, effective and energy-efficient.

The apparatus may accordingly comprise a packing station formed for aseptically packing the sterilised mixture from the process reactor into sterile containers. The packing station may comprise a sealing unit for sterile sealing of the sterile containers after filling, preferably by detectable ultrasound sealing.

The apparatus may further comprise a test unit for testing the animal feed product which is packed into a sterile container and sealed, the test unit being formed to test individual containers for weight and/or tightness and/or seam quality. The testing unit may be integrated into or downstream from the packing station.

The sterile containers are preferably plastics material bags or tubular bags or tubular film bags or pouch bags or film bags comprising or not comprising a standing base or bowls. All these container types are suitable as a result of the above-described packing, and are also particularly light and easy for the consumer to handle. The sterile containers may for example comprise a film of food-safe plastics material such as PET, PE-HD, PE-LD, PP without plasticisers or with food-safe plasticisers. These materials are tried and tested for receiving foodstuffs. The sterile containers may also have an antimicrobial, food-safe coating. Preferably, the sterile containers are manufactured at least in part, in particular entirely, from recyclable material, in particular from mono-PP.

Preferably, the sterile containers have a capacity of at least 100 g or at least 200 g or at least 400 g or at least 1200 g and/or at most 2000 g or at most 1200 g of the sterilised mixture.

The wet food product may comprise the following ingredients of the packaged mixture, in a first embodiment, at
5% by weight or more, optionally 20% by weight or less, fresh edible fungi of the genus Pleurotus,
10% by weight or less plant protein,
0.1% by weight or less proteins of animal origin,
optionally 5% by weight or more vegetables and/or fruit,
15% by weight or less of a source of starch,
2% by weight or less hydrocolloid mixture,
10% by weight or less plant fat or oil,
0.5% by weight seeds,
mineral and vitamin premix (1%-2% by weight) and flavour enhancers (0.5%-2% by weight), remainder water and/or broth (30%-50% by weight),

and, in a second embodiment, at
5% by weight or more, optionally 20% by weight or less, fresh edible fungi of the genus Pleurotus,
0.1% by weight or less plant protein,
20%-30% by weight animal proteins,
optionally 5% by weight or more vegetables and/or fruit,
15% by weight or less of a source of starch,
2% by weight or less hydrocolloid mixture,
0.1% by weight or less plant fat or oil,
0.5% by weight seeds,
mineral and vitamin premix (1%-2% by weight) and flavour enhancers (0.5%-2% by weight), remainder water and/or broth (30%-50% by weight).

Finally, the wet food product may be manufactured by the following steps:
comminuting edible fungi to a particle size substantially corresponding to the particle size of mince, in particular to a hole size of 2 mm-8 mm,
scaling the ground fungi to a predetermined amount and mixing the ground fungi with other vegetables and/or other ingredients to manufacture a non-aqueous component,
mixing cold water, with shear, with a hydrocolloid mixture, starch, plant proteins, oil, vitamins, minerals and flavourings to form an aqueous component,
mixing aqueous and non-aqueous components together and feeding this mixture into a container of the process reactor (102) in the form of a slow cooker,
cooking the mixture under humid conditions at substantially 90° C. for 15 to 25 minutes at a negative pressure of 0.3 bar to 0.5 bar, in particular up to 0.7 bar, which is built up in the slow cooker, while stirring continuously,
after the cooking is finished, sterilising the mixture in the same container at 120° C. or more for 3 minutes at a pressure of 1 bar to 2 bar, optionally also between 2 bar and 3 bar (e.g. between 1 bar and 3 bar),
after the sterilisation, packing the mixture aseptically by weight into preformed bags, a single-phase hot or cold packing process at 80° C. to 85° C. or less being used,
bringing about a phase transition of the homogeneous mass of the mixture from a high-viscosity to a semisolid cohesive mass during packing, the mass being structured by heat-reversible biopolymers and taking on a shape of the packaging.

The term “vegetables” refers to a plant or a part of a plant, a root, a seed or a pod which are consumed by humans or animals as food. The vegetables may preferably be selected from carrots, peas, potatoes, sweet potatoes, pumpkin, courgette, spinach, but are not limited thereto.

The term “fruit” refers to the fleshy or dry matured ovary of a flowering plant, which is sweet and either juicy or fleshy and encloses the seed or seeds. The fruits of these plants may preferably selected from apples, blueberries, mulberries, currants, cranberries, mango, pineapple, but are not limited thereto.

The term “seeds” refers to the small, hard part of a plant from which a new plant grows. The seeds may preferably be selected from chia seeds, sunflower seeds, pumpkin seeds, flax seeds, hemp seeds, sesame seeds, but are not limited thereto.

The term “plant fat or oil” refers to a mixture of triglycerides extracted from plant seeds or other parts of fruits or algae. The plant fat or oil may preferably be selected from sunflower oil (having a high oleic acid content), rapeseed oil, soybean oil, flax oil, olive oil, coconut oil, maize oil, peanut oil, omega-3, but is not limited thereto, algae oils and combinations thereof. The plant fat or oil may contain natural antioxidants such as tocopherols, flavonoids, phenols and phenolic acid from plant extracts and herbs.

The term “broth” refers to a flavour component resulting from the cooking of plant protein sources and/or vegetables. It may be used in liquid, gel or dry form.

The terms “starch” and “hydrocolloids” refer to a group of long-chain polymers or polysaccharides or carbohydrates distinguished by their property of forming viscous dispersions and/or gels when dispersed in water. The source of starch may preferably be selected from maize, wheat, potatoes, tapioca or carbohydrate sources such as pasta, rice, potatoes, sweet potatoes, peas and combinations thereof. The hydrocolloids may preferably be selected from algae extracts, galactomannans, bacterial hydrocolloids, pectin substances extracted from citrus peels and apples, plant fibres. The hydrocolloids are most preferably agar-agar, carrageenan, carob bean gum, guar gum, xanthan gum, pectin, citrus fibres, apple fibres, oat fibres, carrot fibres and gellan.

The heat treatment may comprise heating to a sterilisation temperature and maintaining at the sterilisation temperature for a sterilisation period, the sterilisation temperature preferably being at least 110° C. or at least 120° C. and/or at most 130° C. or at most 125° C. or at most 122° C. or at most 121° C., and the sterilisation period preferably being at most 10 minutes or at most 5 minutes or at most 3 minutes. The sterilisation temperature can thus be selected at a value which ensures a sanitarily flawlessly sterilised wet food product, and the sterilisation period can be kept short so as to detract as little as possible from nutritional content and flavour in the finished wet food product. In the apparatus, the control device may be formed and configured to control the temperature control device in such a way that the components or mixture in the process reactor are brought to a sterilisation temperature having the aforementioned bounds and kept at the sterilisation temperature for a sterilisation period having the aforementioned bounds.

A pressure in the process reactor at least during the heat treatment may be at least 1 bar or at least 2 bar and/or at most 4 bar. In the apparatus, the control device may be formed and configured to maintain a pressure in the process reactor with the aforementioned bounds at least during the heat treatment. Further, the process reactor may be hermetically and tightly sealable, in particular up to 1 bar or 2 bar or 3 bar or 4 bar overpressure. Pressure cooking means that the cooking heated past the boiling temperature of water in a hermetically sealed vessel and thus exposed to the rising and circulating in the container. The water can be heated to 125° C. with an overpressure.

In the context of the method claimed herein, cooking of the mixture in the process reactor at a cooking temperature for a cooking period is preferably provided prior to the sterilisation, the cooking temperature preferably being at most 90° C., particularly preferably at most 95° C. or at most 75° C. or at most 60° C., and the cooking period preferably being at most 40 minutes or at most 30 minutes or at most 20 minutes and/or preferably being at least 5 minutes or at least 10 minutes or at least 15 minutes. Within the meaning of the invention, cooking means a heat treatment which makes the wet food product ready for consumption in terms of flavour, consistency, digestibility and/or effect on health. The cooking process may also contribute to reducing the germ load (pre-sterilisation), and the sterilisation process may also contribute to the cooking process (post-cooking). In turn, it should be appreciated that the cooking and mixing may take place simultaneously. Thus, the three processes of mixing, cooking and sterilisation may be performed in one pass in the same process reactor. This makes possible particularly efficient temperature guidance, a short and gentle processing period, and minimal energy consumption. Process interruptions due to transport or conveying phases can be omitted or reduced to what is unavoidable (storage reactor and reactor packing). A wet food product which has undergone this method is distinguished by particularly well-maintained nutritional content, high tastiness, low manufacturing outlay and a good energy balance.

The mixing may take place while adding further liquid and/or gel and/or powdered and/or piece additives, for example flavourings or flavours. The solid animal feed components may be fed to the process reactor via a funnel and/or a screw conveyor (or more than one screw conveyor). A funnel feed makes rapid filling with large amounts of filling material possible. A screw feed makes a continuous feed from a storage container with exclusion of air possible and can improve automation. Further, continuous feeding of the solid animal feed components and/or sauce or sauce components and/or further components to the process reactor from respective storage containers may be provided. The sauce or sauce components and/or further components may be fed to the process reactor separately from the animal feed components. Naturally, particular components, such as the sauce, may be put together and mixed in advance. The solid animal feed components may also be mixed in advance in accordance with a recipe. The premixed batches may subsequently be fed to the process reactor. A suitable interplay of all these measures makes exact, flexible metering of the various components possible, as well as uncomplicated implementation of individual recipes.

A wet food product manufactured in accordance with the above aspects has a high reproducibility with high flexibility of the recipe and the individual components. The measures contribute to high automation and thus to cost advantages.

The sauce may be prepared by adding the sauce components to water and subsequently mixing the sauce with the solid animal feed components, preferably with further mixing inside the process reactor. Providing the sauce may comprise dispersing a predetermined amount of hydrocolloid mixture, the starch, the plant protein, the plant oil, the minerals, the vitamins, the flavour enhancers in water and mixing the sauce base for several minutes, preferably for at most 10 minutes or at most 5 minutes. The apparatus may further comprise a premixing station for mixing the sauce components, the premixing station preferably being fluidically connected to the process reactor.

The process reactor may have supply elements for supplying further components, such as further liquid and/or gel and/or powdered and/or piece animal feed components and/or additives, for example flavourings, during a sealed state of the process reactor, in particular during an overpressure state of the process reactor. The apparatus may also have a reserve storage station comprising storage containers for storing the solid animal feed components and/or the sauce or sauce components and/or further components. Further, the apparatus may have transport devices for continuously or discontinuously feeding the solid animal feed components and/or the sauce or sauce components and/or further components to the process reactor from respective storage containers.

Once the mixture is sterilised in the process reactor, it can be fed to packing by conveying or transporting continuously or in batches.

The sterilised mixture may be cooled in the process reactor. The cooling may take place for the purposes of subsequent handling and/or to set particular properties, such as a particular hardness, of the mixture. For this purpose, the control device may be formed and configured to temperature-control the process reactor in such a way that a predetermined withdrawal temperature or maturing temperature is reached and optionally maintained for a predetermined maturing period.

Alternatively or in addition, the sterilised mixture may be cooled prior to packing outside the process reactor. For this purpose, a dedicated cooling station may be provided, or a conveyor or transport device may be formed so as to cool the mixture. Further cooling may be provided after packing.

Other details, objects, and advantages of the invention will become apparent as the following description of certain exemplary embodiments thereof and certain exemplary methods of practicing the same proceeds.

### BRIEF DESCRIPTION OF THE DRAWINGS

Further features and advantages of the invention will be apparent from the following detailed description of exemplary embodiments of the invention, from the claims, and from the drawings. In different embodiments, various features may be implemented each individually per se or in a plurality in any desired combinations. In the drawings, like reference signs denote like or corresponding elements.

In the drawings:

FIG. 1 is a schematic block diagram of an apparatus for manufacturing a wet food product in accordance with an exemplary embodiment of the invention.

FIG. 2 is a flow chart of an exemplary embodiment of a method which can be carried out using the apparatus.

### DETAILED DESCRIPTION

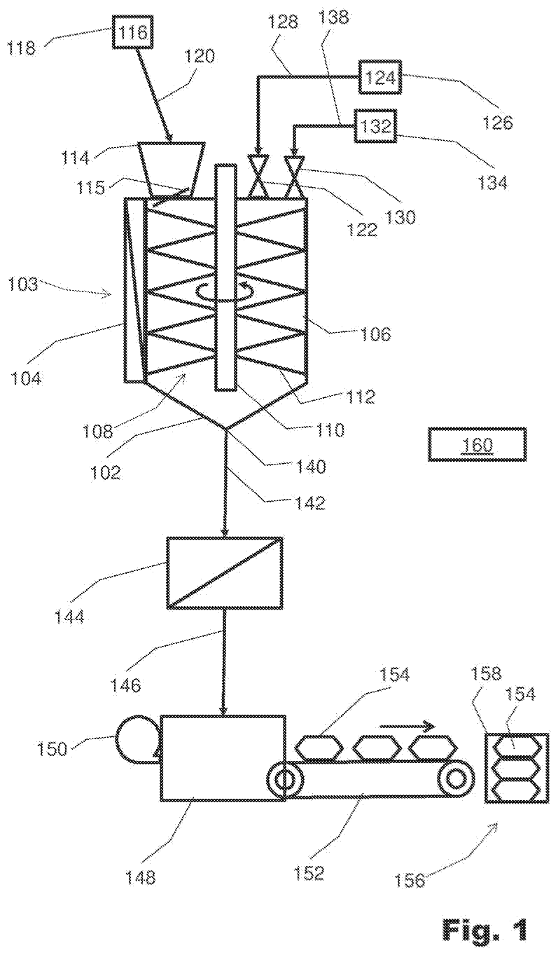

An exemplary embodiment of an apparatus for manufacturing a wet food product for animals, in particular pets is shown schematically in FIG. 1.

The apparatus comprises a process reactor 102. The process reactor 102 is temperature-controllable and may be configured as a slow cooker. For temperature control, one or more hotplates 104 may be provided, of which only one is shown here. The hotplate 104 is arranged and formed to contact a wall 106 of the process reactor 102 so as to temperature-control said wall. The hotplate 104 may be flowed through by a heat transfer fluid, such as water or oil, which can in turn be temperature-controlled by way of a suitable temperature control installation (not shown in greater detail). However, other temperature control systems, for example electrical, are also conceivable. It will be appreciated that the hotplate 104 is merely an example of a temperature control device 103 for temperature-controlling the process reactor 102. Thus, for example, the wall 106 may itself be formed hollow and be flowed through by a heat transfer fluid.

A mixing device 108 is arranged in the process reactor 102. The mixing device may comprise a central shaft 110 and a plurality of mixing blades 112 attached to the shaft 110. The shaft 110 is connected to a drive (not shown in greater detail) which can set the shaft 110 in rotation, making it possible for the mixing blades 112 to rotate in the interior of the process reactor 102. The mixing blades 112 may be formed as scrapers which scrape along on the inner face of the wall 106 of the process reactor 102 so as to scrape off materials deposited there and guide them back into the interior of the process reactor 102. A process reactor 102 of this type, in the form of a scraping heat exchanger, is known per se. It will be appreciated that, although the process reactor 102 is portrayed with a vertical shaft 110 and four mixing blades 112 rotating in a horizontal plane, any known or conceivable variant of a scraping heat exchanger may be used as an embodiment of a slow cooker, as long as the processes can described below be carried out.

The process reactor 102 has a first feed device 114, which in this embodiment is in the form of a funnel. The first feed device 114 is for supplying a solid food component 116 comprising edible fungi and plant and/or animal protein. The solid food component 116 may be stored in a first storage container 118. The first storage container 118 may be connected to the first feed device 114 via a first conveyor device 120. This first conveyor device 120 may for example be a tipping wagon, a conveyor belt, a manually conveyed bucket or the like. The first feed device 114 can be sealed by a flap 115. It should be noted that an opening, into which a screw conveyor or the like opens as a first conveyor device 120, may also be provided as a first feed device instead of the funnel. It will be appreciated that only one solid food component 116 is shown purely for simplicity's sake. Further solid food components may be held in reserve in further storage containers and connected to the first feed device 114 via further conveyor devices or via the same one.

The process reactor 102 comprises a second feed device 122, which in this embodiment is in the form of a fluid connector. The second feed device 122 is for supplying a sauce 124. The sauce 124 may be provided by dispersing a predetermined amount of hydrocolloid mixture, starch, plant protein, plant oil, minerals, vitamins, flavour enhancers in water and mixing the sauce base for several minutes, preferably for at most 10 minutes or at most 5 minutes, for example in the premixing station. The sauce 124 may be stored in a second storage container 126. The second storage container 126 may be connected to the second feed device 122 via a second conveyor device 128. This second conveyor device 128 may for example be a line comprising a pump (not shown in greater detail). The second feed device 122 can be sealed in a manner known per se. It will be appreciated that only a single sauce 124 is shown purely for simplicity's sake. Further sauces or individual sauce components may be held in reserve in further storage containers and connected to the second feed device 122 via further conveyor devices or via the same one. The second conveyor device(s) may comprise a premixing station in which a plurality of sauce components are premixed in accordance with a recipe and conveyed directly to the second feed device 122 or temporarily stored in intermediate containers. The sauce 124 thus represents every possible collection of individual components and/or mixtures which may be supplied to the process reactor 102 via the second feed device 122. A plurality of second feed devices 122 for different sauces or sauce components may also be provided.

The process reactor 102 optionally comprises a third feed device 130, which in this embodiment is in the form of a fluid connector. The third feed device 130 is for supplying a further liquid or paste or gelatinous or oily component 132, which may comprise starch, in particular in the form of a source of starch, oil, in particular plant oil, minerals, vitamins and flavour enhancers. The further components 132 may be stored in a third storage container 134. The third storage container 134 may be connected to the third feed device 130 via a third conveyor device 138. This third conveyor device 130 may for example be a line comprising a pump (not shown in greater detail). The third feed device 130 can be sealed in a manner known per se. It will be appreciated that only one further component 132 is shown purely for simplicity's sake. Further components may be held in reserve in further storage containers and connected to the third feed device 130 via further conveyor devices or via the same one. The third conveyor device(s) may comprise a premixing station in which a plurality of further components are premixed in accordance with a recipe and conveyed directly to the third feed device 130 or temporarily stored in intermediate containers. The component 132 thus represents every possible collection of individual components and/or mixtures which may be supplied to the process reactor 102 via the third feed device 130. A plurality of third feed devices 130 for different components or premixes may also be provided. If the/a further component is water, the container 134 may be replaced with a water line connector. In the process reactor 102, the mixing takes place in such a way that the mixture comprises 5% to 20% by weight edible fungi and either ≤10% by weight plant proteins or 20% to 30% by weight animal proteins. Moreover, in the process reactor 102, the mixture is sterilised by heat treatment, for example using the hotplates 104, in such a way that after sterilisation the mixture has a dry mass content ≤55%, in particular approximately 35% to 18%, and a water activity ≥0.9. In some embodiments, the dry mass content of ≤55% or between 35% and 18% can be a reduction in mass of the mixture via removal of moisture so that the mass of the sterilized mixture is between 55% less and 18% less or between 35% less and 18% less than the wet mass of the mixture prior to the sterilization occurring.

The process reactor 102 comprises an outlet 140. The outlet 140 is optionally connected to a post-cooling station 144 via a fourth conveyor device 142. The fourth conveyor device 142 may be a pipeline, optionally comprising a pump (not shown in greater detail), or a transport wagon track or a conveyor belt comprising intermediate containers or the like. Depending on the type of the fourth conveyor device 142, the post-cooling station 144 may be a through-flow heat exchanger, a continuous-flow cooling chamber, a batch-loadable cooling chamber/refrigerator or the like.

A fifth conveyor device 146 is provided to connect the post-cooling station 144 to a packing station 148. The fifth conveyor device 146 may be of the same type as the fourth conveyor device 142; the two may coincide. The fourth and fifth conveyor device 142, 146, including the post-cooling station 144, in other words the entire path from the process reactor 102 to the packing station 148, are kept as sterile as possible. Preferably, the entire path takes place with exclusion of air in pipes which are sealed airtight or containers which are sealed airtight.

In this embodiment, the packing station 148 is formed to package the mixture fed via the fifth conveyor device 146 into sterile containers 154 under sterile conditions. In the example shown, the containers 154 may for example be tubular film bags. For this purpose, the filling station has for example a film feed 150, in which for example one or more film rolls or folded tube rolls are provided. Packing takes place in a manner known per se, but under sterile conditions. For this purpose, the film is completely disinfected, for example using hydrogen peroxide. The entire packing station 148 is likewise disinfected and subsequently kept sterile using sterile air. The empty containers 154 are pre-formed and filled with portions in accordance with the capacity. The filled containers 154 are sealed in a sterile manner, for example using ultrasound sealing, and leave the packing station 148 via a sixth conveyor device 152, here portrayed as a conveyor belt.

In a packaging station, the individual containers 154 are subsequently packed in outer packaging 158 and fed to delivery. The packaging station 156 or packing station 148 may comprise a test unit for testing the containers 154 for weight, tightness, seam quality and/or the like. Further, a labelling unit (not shown in greater detail) may be provided, which labels the containers 154.

A control device 160 is provided for controlling the apparatus. In particular, the control device 160 is for controlling the temperature control device 103 in terms of a temperature regime in the process reactor 102 and the mixing device 180 in terms of mixing speed and period, as well as the opening/closing state of the flap 115 or other closing elements of the feed devices 114, 122, 130 and outlet 140, the post-cooling station 142, the conveying amounts of the conveyor devices 122, 128, 138, 142, 146, 152, the cooling temperature of the post-cooling station 144. The packing process in the packing station 148 and downstream processes may, but do not have to, be controlled by other control devices or autonomously by the respective stations. The control device 160 may control the apparatus in such a way that the mixture comprises ≤10% by weight plant proteins, ≤1% by weight, in particular ≤0.1% by weight animal proteins, ≤15% by weight source of starch, and ≤15% by weight, preferably ≤10% by weight plant oil, minerals, vitamins and flavour enhancers to obtain a vegan wet food product free of animal feed components. Alternatively, the control device 160 may control the apparatus in such a way that the mixture comprises 20% to 30% by weight animal proteins in the form of meat and/or animal by-products and ≤15% by weight source of starch, oil, minerals, vitamins and flavour enhancers, so as to obtain a flexitarian wet food product.

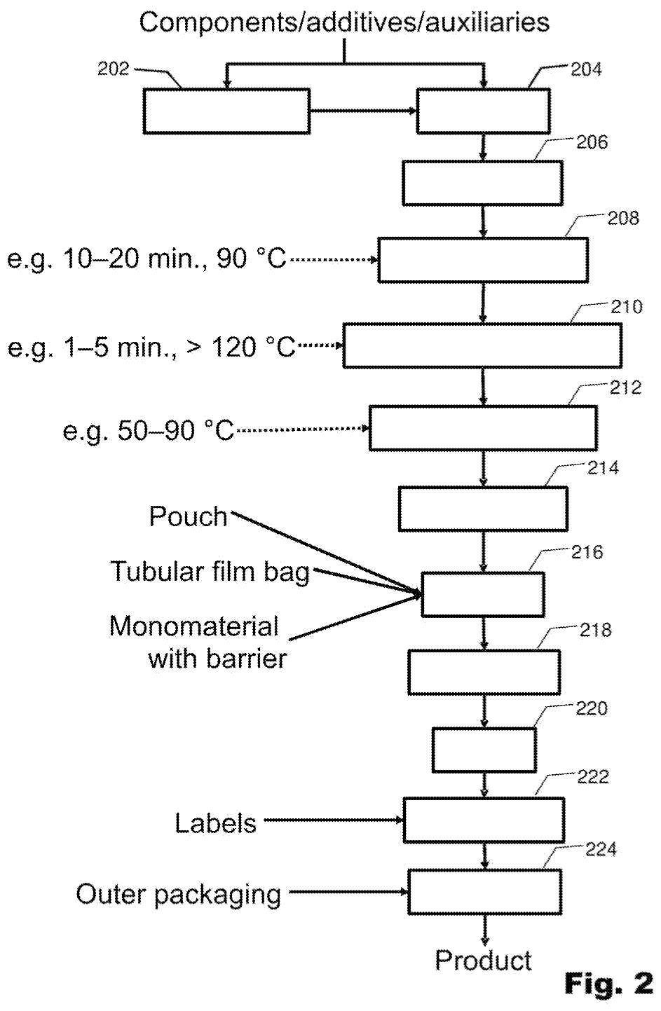

The manufacture of a wet food product using the above-described apparatus is described in greater detail in the following with reference to a flow chart in FIG. 2. Initially, the edible fungi as an animal food component 116 may be comminuted to a particle size substantially corresponding to the particle size of mince, in particular to a hole size of 2-8 mm, followed by scaling the ground fungi to a predetermined amount and mixing the ground fungi with other vegetables and/or other ingredients to manufacture a non-aqueous component. Subsequently, the process reactor 102 is loaded with at least one solid animal food component 116 and at least one sauce 124 via the first feed device 114 and second feed device 122. Further components may be fed via any of the first, second and third feed devices 114, 122, 130. The sauce 124 or other mixtures may be premixed in advance from individual components (step 202). The sealable feed devices 114, 122, 130 may be used to meter the individual components and/or premixes in accordance with a recipe (step 204). Here, cold water may be mixed, with shear, with a hydrocolloid mixture, starch, plant proteins, oil, vitamins, minerals and flavourings to form an aqueous component. In particular, if the sauce alone is not sufficient as process fluid, further components such as water, edible oils or the like may be added.

As regards the composition and recipe, the invention is not limited to particular compositions. However, embodiments of the apparatus and the method of manufacture which can be carried out using the apparatus can be well-suited to the manufacture of wet food using the ingredients described in the following:
The solid pieces may contain a protein-containing meat substitute consisting of edible fungi, selected either from the basidiomycetes belonging to the pleurotaceae family, including Agaricales, Agaricomycetes, or from Pleurotus ostreatus and Pleurotus eryngii, vegetables, fruits, seeds, cheese, real meat, real fish or a combination thereof. The methods for manufacturing the solid foodstuff pieces are known in the art. The solid pieces are bonded together by or contained in a gelled or coagulated aqueous phase. The texture of the gelled wet food product for pets may range from a solid gel to a viscous sauce.
The sauce components may contain salts, flavourings, flavours, colourings, vitamins, micronutrients, herbs, preservatives, antioxidants, emulsifiers and combinations thereof.
Plant protein preferably originates either from pea protein concentrate/isolate, soy protein concentrate/isolate, wheat protein concentrate/isolate, sunflower protein, rapeseed protein, chickpea protein, lupine protein, broad bean protein concentrate, pumpkin seed protein, duckweed protein, mycoprotein, peanut protein, hemp protein, quinoa, chia, amaranth, lentils, chickpeas, buckwheat, spelt, pasta (whole wheat pasta, chickpea pasta), rice and combinations thereof or from legume protein.
Non-plant protein preferably originates from protein sources including, but not limited to, milk protein, egg powder, real meat and/or animal by-products and/or meat derivatives.
Plant fat or oil may preferably be selected from sunflower oil (having a high oleic acid content), rapeseed oil, soybean oil, flax oil, olive oil, coconut oil, maize oil, peanut oil, omega-3, but is not limited thereto, algae oils and combinations thereof.
As carbohydrates, for example pasta, rice, potatoes, sweet potatoes, peas, starches and the like may be used.

The non-starch carbohydrates or hydrocolloids, which may be used in particular for the sauce preparation, include among others algae extracts, galactomannan rubbers, pectic substances such as citrus fibres or apple fibres, and bacterial rubbers. The hydrocolloids may preferably be selected from algae extracts, galactomannans, bacterial hydrocolloids, pectin substances extracted from citrus peels and apples, plant fibres. The hydrocolloids are most preferably agar-agar, carrageenan, carob bean gum, guar gum, xanthan gum, pectin, citrus fibres, apple fibres, oat fibres, carrot fibres and gellan, particularly preferably cassia gum.

After the ingredients have been metered, the process reactor 102 is sealed and the ingredients are blended (step 206), for example after mixing aqueous and non-aqueous components together and feeding this mixture into a container of the process reactor 102, which may be configured as a slow cooker. Blending is understood to mean a first circulation without significant supply of heat. The blending may also take place at least in part with the process reactor 102 still open.

Subsequently, the mixture is cooked while continuing to mix (step 208). For this purpose, the mixture is heated by the temperature control device 103, under the control of the control device 160, to a cooking temperature, for example approximately 90° C. or more, for example approximately 95° C., and kept at the cooking temperature for for example 10 minutes to 20 minutes. Depending on the recipe, cooking temperatures and cooking periods may vary. One embodiment provides cooking the mixture under humid conditions at substantially 90° C. or 95° C. for 15 minutes to 25 minutes at a negative pressure of 0.3 bar to 0.5 bar, in particular up to 0.7 bar, which is built up in the process reactor 102, while stirring continuously.

Subsequently, the mixture is sterilised while continuing to mix (step 210). For this purpose, the mixture is heated by the temperature control device 103, under the control of the control device 160, to a sterilisation temperature, preferably higher than 120° C., and kept at the sterilisation temperature for example 1 minute to 5 minutes. The sterilisation temperature and sterilisation period may vary depending on the recipe, and potentially also depending on a suspected or actual exposure to germs. It is possible, for example, that after the cooking is finished the mixture is sterilised in the same container at 121° C., or else at temperatures higher than 120° C., for 3 minutes at a pressure of 1 bar to 2 bar. Pressures between 2 bar and 3 bar or pressures between 1 bar and 3 bar are also utilizable in some embodiments.

During cooking and sterilisation, the interior of the process reactor 102 may be kept at an overpressure, which may be for example up to 4 bar or even more. All seals, gaskets etc. of the process reactor 102 are configured for these pressures as well as for the temperatures which occur.

After sterilisation, the mixture in the process reactor 102 may be cooled by the temperature control device 103, under the control of the control device 160, and/or stand for a few minutes (step 212), before being withdrawn from the process reactor 102 via the outlet 140. It has been found to be advantageous if the mixture leaves the process reactor 102 at approximately 80° C. to 90° C. for hot packing or at approximately 50° C. for aseptic packing, depending on the relevant product recipe.

Subsequent storage in an aseptic tank 144 for germ-free storage of the sterile product until packing (step 214) is optional.

The packing (step 216) into suitable sterile containers takes place in a manner known per se under sterile conditions. Plastics material bags or tubular bags or tubular film bags or pouch bags or film bags comprising a standing base or bowls comprising a lid of film or thicker material (known as monomaterial with barrier) are particularly, but not exclusively, suitable as containers. The starting material is for example a film of food-safe plastics material such as PET, PE-HD, PE-LD, PP, and/or with an antimicrobial, food-safe coating. The use of a recyclable starting material, such as mono-PP, can improve the environmental assessment. As container sizes, at present those are preferred which have a capacity of at least 100 g or at least 200 g or at least 400 g or at least 800 g or at least 1200 g and/or at most 5000 g or at most 3000 g or at most 2000 g or at most 1200 g of the sterilised mixture. The packing is followed by sterile sealing of the containers (step 218). Processing the starting materials and semi-finished products, filling, and sealing are basically known in the art. The sealing may for example take place by ultrasound. A seam of this type is particularly easily detectable, and so subsequent testing of the filled and sealed container (step 220) for weight, tightness, seam quality and/or further parameters gives reliable results. Step 216 may thus take place in that, after sterilisation, the mixture is packed aseptically by weight into pre-formed bags, using a single-phase hot or cold packing method at 80° C. to 85° C. or less. During filling, a phase transition of the homogeneous mass of the mixture from a high-viscosity to a semi-solid cohesive mass can be brought about, the mass being structured by thermoreversible biopolymers and taking on a shape of the pre-formed bag.

The method is finished by labelling (step 222) and packaging (step 224) the filled and tested containers. Thus, a wet food product suitable for final sale is created, which is sanitary, tasty, nutrient-rich, resource-saving and effective.

It should be noted that the simultaneous mixing and sterilisation of the mixture in the same temperature-controlled process reactor 102 can provide enhanced processing and/or manufacturing. Any state which complies with these process steps, even if it is an intermediate state in the described process, is a wet food product within the meaning of the invention. The further process steps and process parameters are advantageous, but can be modified, omitted or carried out in a different order. For example, separate cooking in the process reactor can be dispensed with if the components are cooked sufficiently by the sterilisation alone, or the components which require cooking may already be held in reserve and metered in in the cooked or pre-cooked state.

In particular, by comparison with conventional sterilisation where wet pet food is subjected to high temperatures and long heating cycles, the aseptic processing makes it possible to sterilise wet pet food using a short heating cycle with temperatures of for example 115-120° C. and a period of for example 3-5 minutes. As a result, the wet food for pets which is processed aseptically using a short-term-/temperature heating method has better retention of nutrients, vitamins, bioactive and heat-sensitive components than the one processed using a long-term-/temperature heating method.

The features of the invention which are described with reference to the portrayed and/or described embodiments may also be present in other embodiments of the invention, unless stated otherwise and unless this is prohibited per se for technical reasons. Moreover, the subject matter of the invention is defined solely by the independent claim or claims. Further subject matters may be formed by any combination of features described herein which is novel in respect of the prior art and solves an objective problem in a non-obvious manner by comparison with said prior art, without the need for other features which are not required for solving this problem to be present, even if these other features are present in the embodiments described herein. Peculiarities of an embodiment should be considered exemplary and optional unless they are specifically claimed independently.

Therefore, while certain exemplary embodiments of the apparatus, food product, and methods of making and using the same have been shown and described above, it is to be distinctly understood that the invention is not limited thereto but may be otherwise variously embodied and practiced within the scope of the following claims.

What is claimed is:

1. A method for manufacturing a wet food product for animals, comprising:
mixing solid animal feed components with a sauce or sauce components in a temperature-controllable process reactor to form a mixture; and
sterilising the mixture by heat treatment in the process reactor.

2. The method of claim 1, wherein:
the mixing is performed so that the solid animal feed components including edible fungi and plant and/or animal protein are mixed with the sauce or sauce components with other components including starch, oil, minerals, vitamins and flavour enhancers in the process reactor to form a mixture that comprises 5% to 20% by weight edible fungi and either ≤10% by weight plant proteins or 20% to 30% by weight animal proteins, and
the sterilising of the mixture occurs by heat treatment in the process reactor so that after sterilisation the mixture has a dry mass content ≤55% and a water activity ≥0.9.

3. The method of claim 2, wherein the mixture comprises:
≤10% by weight plant proteins, ≤1% by weight, animal proteins, ≤15% by weight starch, and ≤15% by weight oil, minerals, vitamins and flavour enhancers to provide a vegan wet food product free of animal feed components;
wherein the plant protein is pea protein concentrate/isolate, soy protein concentrate/isolate, wheat protein concentrate/isolate, sunflower protein, rapeseed protein, chickpea protein, lupine protein, broad bean protein concentrate, pumpkin seed protein, duckweed protein, mycoprotein, peanut protein, hemp protein, quinoa, chia, amaranth, lentils, chickpeas, buckwheat, spelt, pasta, rice and combinations thereof or in a form of legume proteins.

4. The method of claim 2, wherein the mixture is a packed mixture that comprises:
20% to 30% by weight animal proteins in the form of meat and/or animal by-products and ≤15% by weight starch, oil, minerals, vitamins and flavour enhancers.

5. The method of claim 1, comprising:
aseptically packing the sterilised mixture into sterile containers, the sterile containers;
sterile sealing of the sterile containers after filling the sterilised containers with the sterilised mixture.

6. The method of claim 5, wherein the sealing comprises detectable ultrasound sealing and the sterile containers are comprised of plastics material bags or tubular bags or tubular film bags or pouch bags or film bags.

7. The method of claim 1, wherein the heat treatment comprises:
heating to a sterilisation temperature and maintaining at the sterilisation temperature for a sterilisation period, the sterilisation temperature being at least 110° C. and at most 130° C., and the sterilisation period being at most 10 minutes.

8. The method of claim 1, comprising:
maintaining the process reactor at a pressure of at least 1 bar and/or at most 4 bar during the heat treatment.

9. The method of claim 1, comprising:
cooking the mixture in the process reactor at a cooking temperature for a cooking period prior to sterilisation, the cooking temperature being at most 90° C. and the cooking period being at most 40 minutes and being at least 5 minutes.

10. The method of claim 1, comprising:
preparing the sauce by adding the sauce components to water dispersing a predetermined amount of a hydrocolloid mixture, starch, plant protein, plant oil, minerals, vitamins, and flavour enhancers in water and mixing the sauce base for at most 10 minutes;
and wherein the mixing comprising mixing the sauce formed via the preparing of the sauce with the solid animal feed components inside the process reactor.

11. The method of claim 1, wherein the mixture comprises:
between 5% by weight and 20% by weight fresh edible fungi of the genus Pleurotus,
10% by weight or less plant protein,
0.1% by weight or less proteins of animal origin,
15% by weight or less of a source of starch,
2% by weight or less hydrocolloid mixture,
10% by weight or less plant fat or oil,
0.5% by weight seeds,
1%-2% by weight a mineral and vitamin premix,
0.5%-2% by weight flavour enhancers, and
30%-50% by weight water and/or broth;
or
between 5% by weight and 20% by weight fresh edible fungi of the genus Pleurotus,
0.1% by weight or less plant protein,
20%-30% by weight animal proteins,
15% by weight or less of a source of starch,
2% by weight or less hydrocolloid mixture,
0.1% by weight or less plant oil,
0.5% by weight seeds,
1%-2% by weight a mineral and vitamin premix,
0.5%-2% by weight flavour enhancers, and
30%-50% by weight water and/or broth.

12. The method of claim 11, wherein the mixture also comprises at least 5% by weight vegetables and/or fruit.

13. The method of claim 1, comprising:
comminuting edible fungi to a particle size substantially corresponding to a particle size of mince,
scaling the comminuted fungi to a predetermined amount and mixing the comminuted fungi with other vegetables and/or other ingredients to manufacture a non-aqueous component,
mixing cold water with a hydrocolloid mixture, starch, plant proteins, oil, vitamins, minerals and flavourings to form an aqueous component,
mixing the aqueous component and the non-aqueous component together and feeding the mixed aqueous component and the non-aqueous component into the process reactor, the process reactor configured as a slow cooker,
wherein the mixing of the solid animal feed components with the sauce or sauce components comprises cooking the mixed aqueous component and non-aqueous component under humid conditions at 90° C. for 15 minutes to 25 minutes at a negative pressure of 0.3 bar to 0.5 bar while stirring continuously, and
wherein the sterilising is performed after the cooking is finished, the sterilising of the mixture being performed in the process reactor at 120° C. or more for 3 minutes at a pressure of 1 bar to 2 bar;
the method also comprising:
after the sterilisation, packing the mixture aseptically by weight into preformed bags via a single-phase hot or cold packing process at 85° C. or less being used,
bringing about a phase transition of a homogeneous mass of the mixture from a high-viscosity to a semisolid cohesive mass during the packing, the mass being structured by heat-reversible biopolymers and taking on a shape of the packaging.

14. A wet food product for animals manufactured by the method of claim 1.

15. An apparatus for manufacturing a wet food product for animals comprising:
a process reactor configured to receive solid animal feed components and a sauce or sauce components,
a temperature control device configured to control a temperature of one or more walls of the process reactor,
a mixing device positioned and configured to mix the solid animal feed components and the sauce or the sauce components in the process reactor to form a mixture, and
a control device configured to control the mixing device to mix the solid animal feed components and the sauce or the sauce components in the process reactor and to control the temperature control device to sterilise the solid animal feed components and the sauce or the sauce components or the mixture in the process reactor via heat treatment.

16. The apparatus of claim 15, wherein the process reactor is configured as a slow cooker.

17. The apparatus of claim 15, wherein:
the solid animal feed components include:
edible fungi and plant and/or animal protein;
the sauce or sauce components include starch, oil, minerals, vitamins and flavour enhancers,
the mixing device is configured to form the mixture so the mixture comprises 5% to 20% by weight edible fungi and either ≤10% by weight plant proteins or 20% to 30% by weight animal proteins, and
the control device is configured to control the mixing device to control the temperature control device so as to sterilise the solid animal feed components and the sauce or the sauce components or the mixture in the process reactor by heat treatment so that after sterilisation the mixture has a dry mass content ≤35%-18%, and a water activity ≥0.9.

18. The apparatus of claim 15, wherein the control device is configured to control the process reactor so that the mixture comprises ≤10% by weight plant proteins, ≤1% by weight animal proteins, ≤15% by weight source of starch, and ≤15% by weight plant oil, minerals, vitamins and flavour enhancers to provide a vegan wet food product free of animal feed components.

19. The apparatus of claim 15, wherein the control device is configured to control the process reactor so that the mixture comprises 20% to 30% by weight animal proteins in the form of meat and/or animal by-products and ≤15% by weight starch, oil, minerals, vitamins and flavour enhancers.
